(19) United States
(12) Patent Application Publication
(10) Pub. No.: US 2002/0174736 A1
(43) Pub. Date: Nov. 28, 2002

(54) Precision control joystick unit

(76) Inventor: Leonard T. Chapman, North Hollywood, CA (US)

Correspondence Address: LYON & LYON LLP, 633 WEST FIFTH STREET, SUITE 4700, LOS ANGELES, CA, 90071, US

(21) Appl. No.: 09/864,622

(22) Filed: May 24, 2001

(51) Int. Cl. G05G 9/00

(52) U.S. Cl. 74/471 XY

(57) ABSTRACT

In a precision control joystick unit, a first housing is pivotally attached to a second housing. A control stick extending out of the first housing is pivotable in a front/back direction relative to the first housing. The control stick moves a first cam in the first housing, which drives a gear to turn a potentiometer shaft. A pair of damped force/spring cylinders act to return the control stick to a center position, when the user releases the control stick. The second housing similarly includes a second cam linked to a second potentiometer through gears, and a second set of return cylinders. A second cam driver pivots with the first housing, so that side-to-side movement of the stick pivots the first housing relative to the second housing and actuates the second potentiometer.

### BACKGROUND OF THE INVENTION

Joystick controllers have long been used in toys and games, computer equipment, industrial equipment, medical/surgical devices, military equipment, and in other ways where control in two dimensions is needed or desired. Typically, a joystick controller has a stick movable in two dimensions about a pivot or ball joint. The movement of the stick is then generally converted into electrical control signals, either within the joystick controller itself, or via remote circuitry electrically linked to the joystick controller. Typically, the joystick controller has a device, such as a bellows, boot, spring, etc. which returns the joystick to a center or neutral position, when the joystick is released from hand or finger force. As joystick controllers provide for convenient, fast, and accurate control, they have been widely used in many applications. In addition, using appropriate circuitry or control software, movement of a joystick in a joystick controller may provide linear, proportional, exponential, or other two-dimensional control. Three dimensional control may also be provided using a joystick sensing vertical forces, by using two joysticks, and in other ways.

In many joystick controllers, the stick is mechanically linked to a potentiometer or variable resistor, or linked with a non-contact magnetic device. To adjust the sensitivity of the controller, gears or other mechanical linkages have been provided between the stick and the potentiometer. This better allows the ergonomics of the operator's hand/stick movement to provide the desired control output signal. However, the need for smooth hand control of a joystick controller, by reducing the sensitivity of stick movements, may conflict with the ability of the joystick controller to provide a wide range of control signals. For example, many joystick controllers use potentiometers which can be varied from a minimum to a maximum electrical resistance with a turning movement of up to about 150-180°. While some potentiometers can be varied from a minimum to a maximum resistance over a broader turning range of movement (some even exceeding 360° of movement), these potentiometers typically require internal gearing or other complicating design factors, which may increase the cost and reduce the precision control of the potentiometer.

Due to ergonomic factors, stick movement in joystick controllers is typically limited to ±45° from center, and perhaps up to even +600 from center. Stick movement beyond these limits becomes difficult or impossible to provide, due to the mechanical design of the joystick controller, and to the ergonomic disadvantages in achieving precise hand/stick movement, as the stick approaches a horizontal position. Accordingly, design challenges remain in providing a precision control joystick where the stick moves within a nominal range of ±45°, 50°, 55° or 60° while at the same time, potentiometer movement of e.g. 150°, 165° or even 180° is achieved (without movement multiplying devices within the potentiometer) and while maintaining a sensitivity level facilitating precision hand/stick control. More generally, design challenges remain in providing precision control with a joystick, regardless of the ranges of operation. Human hand control difficulties include hand tremors which generate unwanted signal generation. This should be eliminated to provide maximum control.

### SUMMARY OF THE INVENTION

In a first aspect, a precision control joystick unit includes a control stick pivotally attached to a first housing or plate. A first end of the control stick is in contact with, or positioned to come into contact with, a first cam. A first converter, such as a potentiometer, is mechanically linked to the first cam. A converter is any device that converts physical hand movement into an electrical control signal. The first housing or plate is pivotably attached to a second housing or plate. An extension or shaft on the first housing is in at least indirect contact, or contactable with, a second cam associated with the second housing. A second converter or potentiometer is mechanically linked to the second cam. Movement of the control stick in a first direction mechanically moves or adjusts the first converter, via the first cam. Movement of the control stick in a second direction, perpendicular to the first direction, moves the first housing or plate, which in turn adjusts or moves the second converter, via the second cam. Consequently, precision control is available over substantially the entire range of control stick and converter movement. Preferably, the second housing or plate is fixed to a base, or other non-moving structure.

In a second aspect, a first cam gear is attached to the first cam and engaged with a first converter gear on the first converter, to provide a gear ratio between movement of the first cam, and adjusting movement of the first converter.

In a third aspect of the invention, a pair of return actuators are mechanically attached, directly or indirectly, to the first cam. The return actuators provide a damped return force tending to return the control stick to a center or neutral position, with a smooth movement, and without overshooting the center position. This hydraulically clamped spring biased system eliminates or reduces hand tremors, providing improved accuracy. Release of the control stick will result in a smooth hydraulically controlled return movement to the center (or off) position.

In a fourth aspect of the invention, the first converter can be precisely adjusted via opposing set screws. The converter electrical output signal can be finely adjusted (e.g., to a zero output) by movement of the set screws, which are able to precisely turn the converter, or converter housing, relative to the converter shaft or movable element.

Accordingly, it is an object of the invention to provide an improved precision control joystick unit. The invention resides as well in subcombinations of the elements and features described.

### BRIEF DESCRIPTION OF THE DRAWINGS

In the drawings, wherein the same reference number indicates the same element, throughout the several views:

FIG. 1 is a side view, in part section, of the present joystick control unit, with the stick in the zero, neutral or center position.

FIG. 2 is a partial side view thereof, illustrating the pivoting movement of the second housing relative to the first housing of the joystick control unit shown in FIG. 1.

FIG. 3 is a partial section view taken along line 3-3 of FIG. 1, and with certain components omitted for clarity of illustration.

FIG. 4 is a side view of the joystick controller shown in FIG. 1, with the stick at a 45° position.

FIG. 5 is a side view of the cam shown in FIGS. 1 and 4.

FIG. 6 is a front view thereof.

FIGS. 7a, 7b, 7c and 7d show alternative cam designs.

FIG. 8 is a graph of cam movement v. stick movement.

### DETAILED DESCRIPTION OF THE DRAWINGS

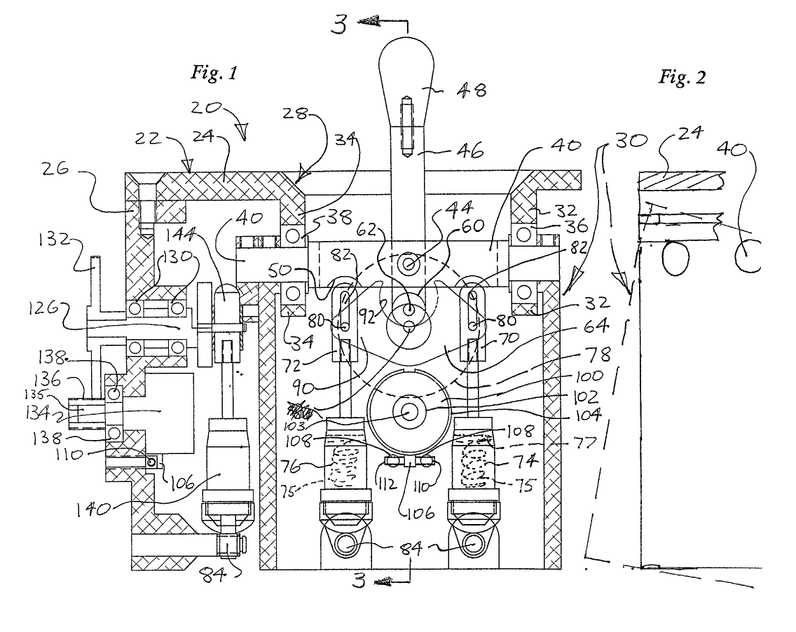

Turning now to the drawings, as shown in FIG. 1, a precision control joystick unit 20 includes a second housing or plate 22, and a first housing or plate 30 pivotably attached to the second housing 22. Ordinarily, the second housing 22 is fixed in place, e.g., attached to a base plate, control panel, etc., with the first housing 30 able to pivot relative to the second housing 22. The second housing 22 includes a top plate 24 having a stick opening 28. A side plate 26 is attached to the top plate 24, preferably with screw fasteners.

The ends of a shaft 40 are supported on the top plate 24 by an outer bearing 36 and an inner bearing 38. The bearings 36 and 38 are pressed into or otherwise held in place within an outer bearing block 32 and an inner bearing block 34, respectively. Edge crimps or adhesives can secure the bearings from lateral movement. The first housing 30 is preferably fixed or attached onto the ends of the shaft 40 by set screws or other attachment.

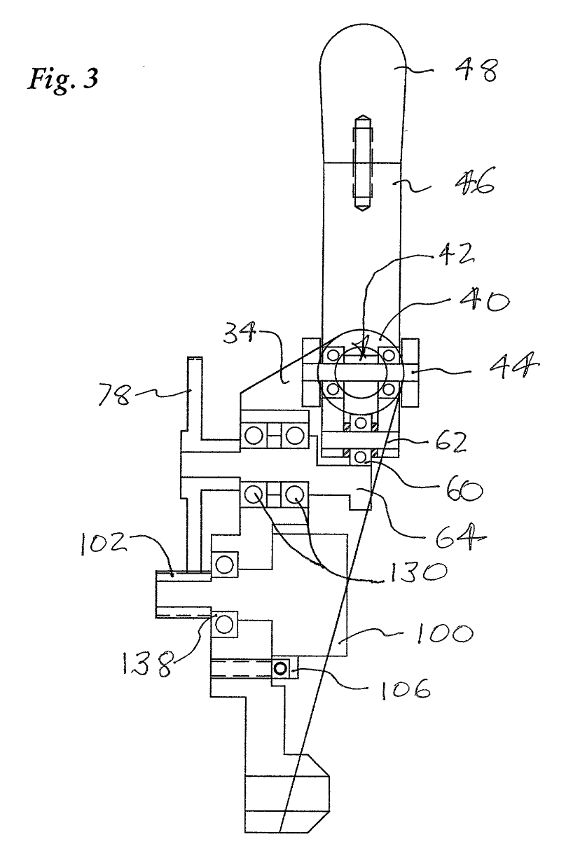

A slot 42 extends through the shaft 40 as shown in FIG. 3. A stick 46 extends through the slot 42 and is pivotably attached to the shaft 40 with a shaft pin 44. A cap 48 is attached onto the upper end of the stick 46.

Referring still to FIG. 1, a cam roller 60 is rotatably supported on the lower end of the stick 46, on a roller axle or pin 62. The lower ends of an outer or first cylinder 74, and an inner or second cylinder 76, are pivotably attached to the second housing 30 at pivot mounts 84. A shaft extending out of the first cylinder 74 and the second cylinder 76 is attached to 20 (preferably threaded into) an outer or first clevis 70 and an inner or second clevis 72, respectively. Each clevis 70 and 72 has a clevis slot 82. Clearance slots 50 are cut into the bottom surface of the shaft 40, to provide clearance for the clevis 70 and 72.

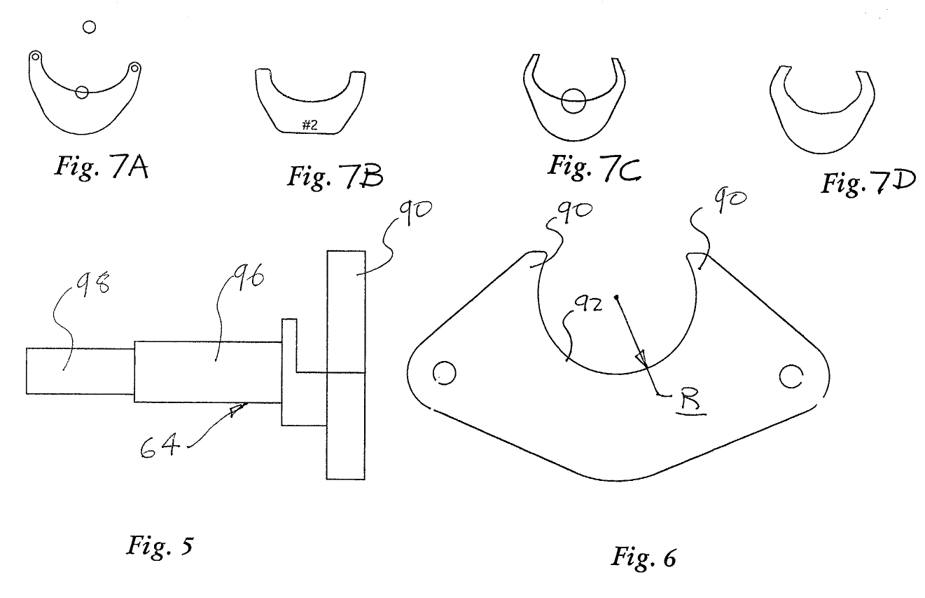

An anti-backlash cam gear 78 is attached to a cam 64. Cam gear pins 80 extend from the side of the gear 78, through the clevis slots 82 in the clevis 70 and 72, and into the cam 64. A cam surface 92 is formed on the cam 64, between the cam arms 90 attached to the gear 78 by the pins 80. As shown in FIGS. 5 and 6, the cam 64 includes a bearing shaft section 96 and a gear shaft section 98. The bearing shaft section 96 is supported on a bearing within the second housing 30, to fix the gear center of the gear 78, which is mounted on the gear shaft section 98.

Referring back momentarily to FIG. 1, a converter, for converting mechanical movement into a corresponding electrical signal (or electrical signal function) such as a potentiometer 100, includes a converter gear 102 mounted on a shaft 103, with turning movement of the shaft 103 varying the resistance or other output. A split ring clamp or housing 104 attached around the converter 100 has a clamp tab 106 precisely movable by advancing a first set screw 110, while backing out a second opposing set screw 1 12.

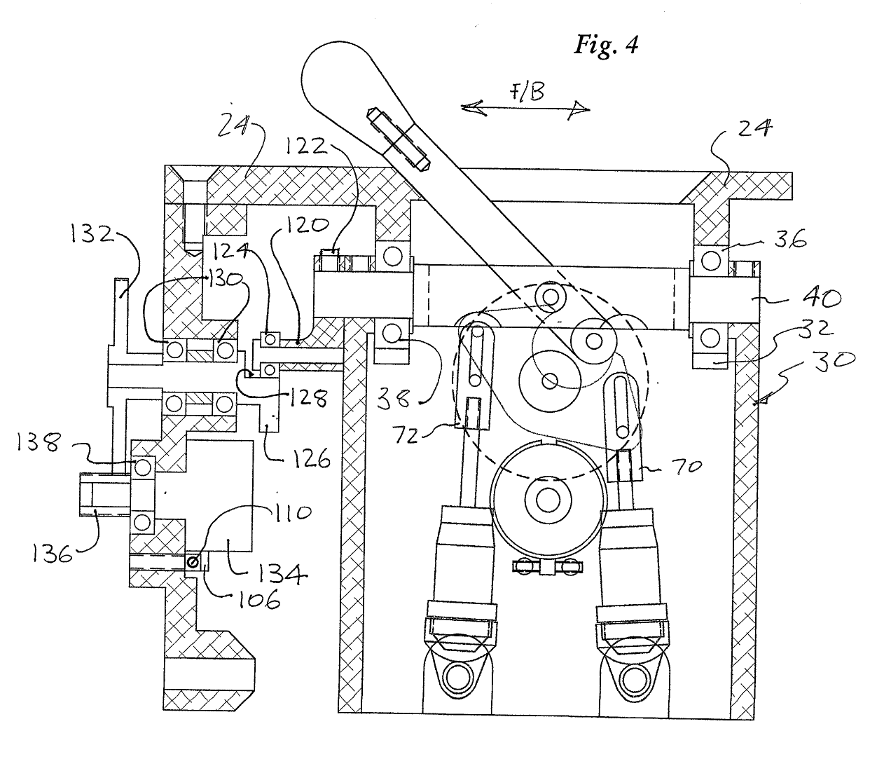

Referring to FIG. 4, a housing extension 120 is attached to, and pivots with the first or pivoting housing 30, for example, by attaching the housing extension 120 to the inner end of the shaft 40 with a set screw 122, or other attachment technique.

Referring to FIGS. 1 and 3, a second cam 126 is pivotably or rotatably supported within the side plate 26 or other structure of the first housing 22 on bearings 130. A second antibacklash gear 132 is attached to the gear shaft section of the second cam 126. A second converter or potentiometer 134 is supported on the side plate 26 or other structure of the first housing 22 on a bearing 138. A second potentiometer gear 136 on the shaft 135 of the second converter 134 engages or meshes with the second gear 132. A split ring clamp 104 and set screws 110 and 112 are provided on the second converter 134, as described above with respect to the first converter 100. Cylinders 140 and 142 (not shown in FIG. 1) are attached to the second cam 126 on a clevis 144 and 146 (not shown in FIG. 1), as described above with reference to the first cam 64.

A second cam roller 124 on the housing extension 120 rolls on a cam surface 128 of the second cam 126, as shown in FIG. 4.

In use, as the stick 46 is moved in the front/back direction (indicated by the arrow F/B in FIG. 4), the stick 46 pivots about the pin or axle 44, and the cam roller 60 rolls on the cam surface 92. Referring to FIG. 4, movement of the cam roller 60 on the cam surface 92 causes the cam 64 and the gear 78 attached to the cam 64, to turn. As this occurs, with the stick pushed forward as shown in FIG. 4, the clevis 70 and shaft of the outer cylinder 74 move down, with the shaft retracting into the body of the cylinder 74. At the same time, the gear 78 drives the converter gear 102, causing the converter 100 to provide an electrical output varying as a function of the position of the stick 46.

With side-to-side movement, perpendicular to the direction F/B, the stick 46 cannot pivot relative to the first housing 30. However, as the stick 46 is moved to one side, by the user's hand, the entire second housing 30 pivots relative to the first housing 22, as shown in dotted lines in FIG. 2. As this occurs, the second cam roller 124 drives the second cam 126, which turns the second gear 132. Correspondingly, the shaft 135 and gear 136 of the second converter turn. The second converter 134 then provides an electrical output varying as a function of the side-to-side position of the stick 46 and housing 30, relative to the housing 22.

The cylinders 74, 76, 140 and 142, preferably each contain a spring 75 and a fluid dampener 77. The cylinders act to provide controlled and vibration-fee return of the cams, gears and stick 46 back to the central or neutral position, shown in FIG. 1, after or as the stick 46 is released. The spring 75 constantly exerts a return force on the spring which varies generally linearly with cylinder rod displacement. The clevis 70, 72, 144 and 146 is preferably threaded onto the shaft of its associated cylinder, so that the vertical position of the slot 82 in each clevis can be adjusted during manufacture of the control unit 20. The split ring clamp 104, clamp tab 106, and set screws 110 and 112 are similarly provided with each converter 100 and 134, to calibrate the converter, during manufacture or to zero out drift during servicing. To set the converters 100 and 134 to a zero position, the output or resistance of each converter is monitored while the set screws 110 and 112 are manipulated to turn the converter slightly relative to the shaft 103 or 135, until the desired converter output is achieved. Both set screws 110 and 112 are then tightened, to lock the converter into the desired position. As even slight relative movements between the converter and its shaft can vary the converter resistance or output, use of the set screws 110 and 112 better facilitates calibration.

The ratio between the gears 78 and 102, and 132 and 136, respectively, preferably ranges from 3:1 to 7:1 or 4:1 to 6:1. In the embodiment shown in the drawings, the ratio is 5:1. The gears 78 and 102, and 132 and 136, preferably have anti-backlash features, such as spring biased split gear sections. However, other types of gears or connections can be used.

The converters or potentiometers 100 and 134 are preferably connected in series with a speed setting potentiometer (within the control unit 20, or elsewhere in the control system) to select speed control ranges.

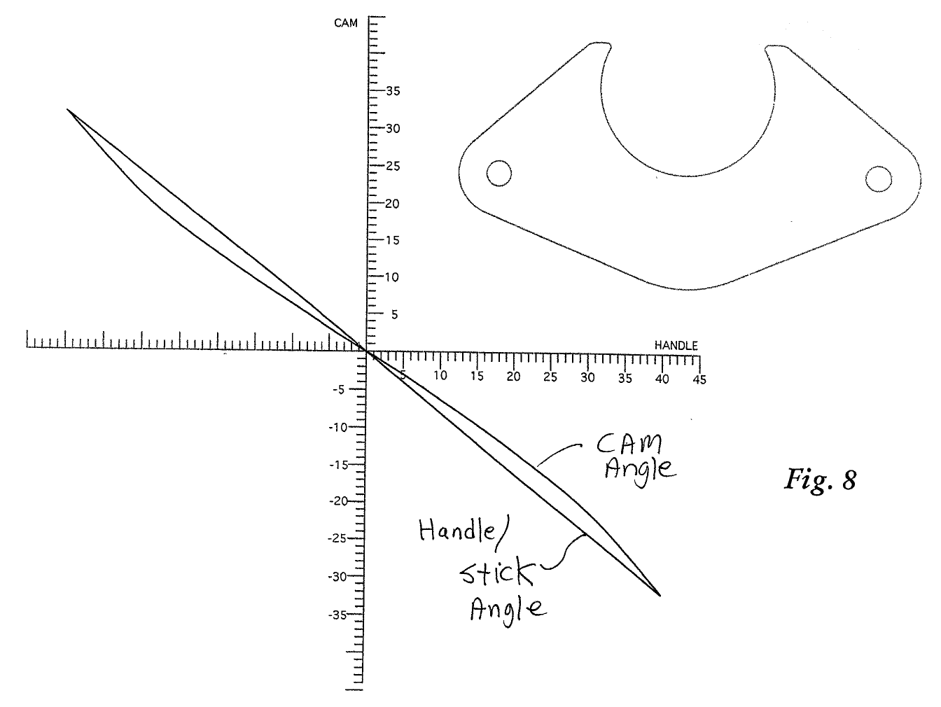

The cam surface 92 on both cams 64 and 126, is preferably circular. However, shapes such as elliptical shown in FIG. 7a, oval as shown in FIG. 7b, flattened oval as shown in FIG. 7c, or segmented oval, as shown in FIG. 7d, as well as other shapes, may also be used. The shape of the cam surface 92, and the size of the cam surface 92 affect the sensitivity of the control unit 20. The larger the radius R in FIG. 6, or other characteristic dimension of a non-circular cam surface, the less sensitive the control unit will be, i.e., more stick movement will be needed to achieve a given converter output. Similarly, the flatter the cam surface, the more slowly stick movement will affect converter output. The shape of the cam selected can increase or decrease the sinusoidal deviation from a straight line graph. See FIG. 8.

The cam rollers 60 and 124 are preferably bearings which roll on the cam surface 92. However, a bushing or sliding element may also be used.

The sensitivity of the control unit 20 may also be adjusted by varying the gear ratios. For use with standard and commercially available potentiometers 100 and 134 (having a 150° range of shaft movement) to be able to achieve a full range or potentiometer settings or positions, the minimum gear ratios are preferably 3:1 or 4: 1.

The cam rollers 60 and 124 are preferably, but not necessarily, contacting the cam surface 92, at all times. The cam surface 92 may be configured so that at the zero or center position, or at other positions at or near the end limit of travel, a small gap remains between the cam rollers and cam surface.

As the stick 46 is manipulated, one pin 80 moves down with one side of the cam and the associated clevis, such as the clevis 70 in FIG. 4, while the other pin 80 in the other clevis (clevis 72 in FIG. 4) moves up within the clevis slot 82. The cylinders 74 and 76 are both shown in their fully extended positions in FIG. 1.

The side-to-side or second axis system provided by the second cam 126, second gear 132, second converter 134 and second cylinders 140 and 142 operate in the same way, and with the same design as the F/B or first axis system described above and including the first cam 64, first gear 78, first converter 100 and cylinders 74 and 76. The cylinders provide an accurate zero position for the gears, when the cylinders are fully extended.

As shown in FIG. 8, the cam surface 92 reduces the amount of gear movement induced by movement of the stick 46, reducing the sensitivity of the control unit 20. As shown in FIG. 8, e.g., 5° of handle movement is reduced to 3-4° of cam movement in the ranges shown. Greater variation can be achieved, as required, by cam shaping.

Various equivalents may be used for the fasteners and attachments shown and described, including other types of fasteners, adhesives, welding, integral construction, etc. In addition, various equivalents may be used in place of the bearings and rollers shown and described, including bushings, low friction surfaces, lubricants, etc. Various of the components shown and described may also be combined into a single component, rather than being multiple components, as shown, or components shown and described as single components may be divided into two components or multiple components.

Thus, a novel precision joystick control unit has been shown and described. Various changes and modifications and substitutions may be made without departing from the spirit and scope of the invention. The invention, therefore, should not be limited, except by the following claims, and their equivalents.

1. A precision control joystick unit, comprising:
a control stick pivotally attached to a shaft with the control stick having a first end in at least indirect contact with a first cam;
a first converter linked to the first cam;
a second cam in at least indirect contact with the shaft; and
a second converter linked to the second cam.

2. The control unit of claim 1 where the first converter is a variable resistor.

3. The control unit of claim 1 where the control stick is pivotable in a first direction relative to the shaft, and the shaft is pivotable in a second direction relative to the second cam, and with the first direction perpendicular to the second direction.

4. The control unit of claim 1 with the second cam and the second converter attached to a second housing, and with the first cam and the first converter attached to a first housing, and with the first housing pivotable relative to the second housing.

5. The control unit of claim 4 where the second housing is fixed to a base and the first housing is pivotable on the second housing.

6. The control unit of claim 5 where the stick is pivotable in a first direction relative to the shaft, and the first housing is pivotable in a second direction relative to the second housing, and with the second direction perpendicular to the first direction.

7. The control unit of claim 1 further including a first cam gear attached to the first cam and engaged to a first converter gear on the first converter.

8. The control unit of claim 1 further including at least one return actuator attached at least indirectly to the first cam.

9. The control unit of claim 8 where the return actuator comprises a cylinder providing a damped return force.

10. The control unit of claim 9 where the return actuator includes a spring and a viscous damper.

11. The control unit of claim 8 further comprising a pair of return actuators attached at opposite ends of the cam.

12. The control unit of claim 5 further comprising a first pair of spaced apart return actuators each having a first end pivotally attached to the first housing, and each having a second end attached to a slotted clevis, and with the first cam having a pair of pins extending into the slots in the clevis.

13. The control unit of claim 1 further comprising a bearing between the first end of the stick and the first cam.

14. The control unit of claim 5 further including a converter clamp on the first converter and a pair of opposing adjustment screws supported at least indirectly on the first housing and engageable to the clamp.

15. The control unit of claim 1 further comprising a first speed selection converter linked to at least one of the first converter and the second converter.

16. A control unit comprising:
a first housing pivotally attached to a second housing;
a control stick extending out of the first housing and pivotable in first direction relative to the first housing;
a first cam in the first housing movable by the control stick;
a first converter in the first housing and having a first converter gear meshed with
a first cam gear on the first cam;
a first return spring element attached to the first housing and to the first cam or first cam gear, for biasing the control stick to a center position;
a first dampening element attached to the first housing and to the first cam or first gear, for dampening movement of the control stick;
a second cam in the second housing;
a second cam driver fixed to and pivotable with the first housing, and engaged to the second cam, with the second cam movable by the second cam driver;
a second converter in the second housing and having a second converter gear meshed with a second cam gear on the second cam;
a second return spring element attached to the second housing and to the second cam or second cam gear, for biasing the first housing to a center position;
a second dampening element attached to the second housing and to the second cam or second cam gear, for dampening movement of the first housing relative to the second housing.

17. The control unit of claim 16 where the first housing is pivotally supported on a shaft relative to the second housing, and with the control stick extending through a slot in the shaft and pivotally attached to the shaft.

18. The control unit of claim 16 where the first and second cams have circumferential cam surfaces, so that linear movement of the control stick creates a sinusoidal output from the first and second converters.

19. The control unit of claim 16 where the gear ratio of the first cam gear to the first converter gear is from 3:1 to 6:1.

20. The control unit of claim 16 where pivoting movement of the first cam is less than pivoting movement of the stick driving the cam.

21. The control unit of claim 16 where the first and second converter gears are attached to first and second converter shafts in the first and second converters, respectively, and with the first converter shaft extending in a direction perpendicular to the second converter shaft.

22. The controller of claim 16 where the control stick is pivotable +/− from about 30 to 60 degrees, and the first converter gear is correspondingly rotatable +/− from about 90 to 360 degrees.

23. The controller of claim 16 where the control stick is not in contact with first cam when the control stick is at the center position.

24. The controller of claim 16 where the size and shape of first cam and the ratio of first cam gear and the first converter gear are selected so that 45 degrees of movement of the control stick, relative to the first housing, provides at least 60-120 degrees of movement of the first converter gear.
